(19) United States
(12) Patent Application Publication
(10) Pub. No.: US 2014/0263837 A1
(43) Pub. Date: Sep. 18, 2014

(54) NACELLE INLET THERMAL ANTI-ICE SPRAY DUCT

(71) Applicant: SPIRIT AEROSYSTEMS, INC., Wichita, KS (US)

(72) Inventor: Joe Everet Sternberger, Wichita, KS (US)

(73) Assignee: SPIRIT AEROSYSTEMS, INC., Wichita, KS (US)

(21) Appl. No.: 13/797,273

(22) Filed: Mar. 12, 2013

(51) Int. Cl. B64D 15/04

(52) U.S. Cl. CPC B64D 15/04
USPC 244/134 B

(57) ABSTRACT

An anti-icing system for a nacelle inlet of an aircraft engine includes a spray tube for directing hot gasses toward a portion of the nacelle inlet. The spray tube includes a plurality of sections arranged such that the ends of adjacent sections are separated by a space thereby defining a thermal expansion gap between the sections. A plurality of expansion joints interconnect adjacent ends of the spray tube sections and enclose the expansion gaps. The joints allow the spray tube to expand and contract without adversely affecting the performance or structure of the spray tube. Annular sealing elements positioned in opposed axial margins of the expansion joints provide an air-tight or nearly air-tight seal between the expansion joints and the spray tube sections.

### FIELD

Embodiments of the present invention relate to aircraft engine assemblies. More particularly, embodiments of the present invention relate to an anti-icing system for a nacelle inlet of an aircraft engine assembly.

### BACKGROUND

Anti-icing systems are commonly used for preventing ice from accumulating on the leading edges of aircraft structures such as engine inlets and wings. One prior art anti-icing system includes a piccolo-type spray tube which directs hot gasses from an aircraft's engine toward an area to be de-iced. One problem with these types of systems is that the spray tube is alternatively subjected to relatively low ambient temperatures when the aircraft is not in use and extremely high temperatures when hot gasses are passed therethrough, resulting in cyclic thermal expansions and contractions of the tube. Such expansions and contractions can damage the tube itself and the brackets or other supports which attach the tube to the aircraft. Damaged tubes and brackets are difficult to repair because they are typically mounted inside an engine nacelle or other component and are therefore hard to access. Moreover, damaged tubes can jeopardize aircraft safety because they may no longer direct the hot gasses to the areas which require de-icing and may even misdirect the gasses to fragile areas of the aircraft nacelle or other component.

The above section provides background information related to the present disclosure which is not necessarily prior art.

### SUMMARY

Embodiments of the present invention solve the above-described problems and provide a distinct advance in the art of aircraft anti-icing systems. More particularly, embodiments of the present invention provide an anti-icing system for a leading edge of an aircraft which more effectively accommodates thermal expansions and contractions of components of the anti-icing system.

An anti-icing system constructed in accordance with an embodiment of the present invention comprises a spray tube for directing hot gasses toward a portion of a nacelle inlet, wherein the spray tube comprises a plurality of sections arranged such that the ends of adjacent sections are separated by a space thereby defining a thermal expansion gap between the sections. A plurality of expansion joints connect adjacent ends of the tube sections to thereby enclose the thermal expansion gap defined by the adjacent ends. Each expansion joint allows the adjacent ends of the tube sections to move within the joint.

An anti-icing system for a nacelle inlet of an aircraft engine constructed in accordance with another embodiment of the invention comprises a circular spray tube for directing hot gasses toward a portion of a nacelle inlet, wherein the spray tube comprising a plurality of arcuate sections arranged such that the ends of adjacent sections are separated by a space thereby defining a thermal expansion gap between the sections. A plurality of expansion joints are rigidly connected to a support structure of the aircraft engine and connecting adjacent ends of the tube sections to thereby enclose the thermal expansion gap defined by the adjacent ends. Each expansion joint allows the adjacent ends of the tube sections to move within the joint. A plurality of fixed supports rigidly connect the spray tube sections to the support structure of the aircraft engine.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### DRAWINGS

Embodiments of the present invention are described in detail below with reference to the attached drawing figures, wherein:

FIG. 1 is a side elevation view of an aircraft engine assembly in which embodiments of the present invention may be implemented.

FIG. 2 is a side elevation view of a portion of a nacelle assembly with components of the anti-icing system shown mounted therein.

FIG. 3 is an isometric view of an inlet portion of the nacelle shown with its outer panel and acoustic panels removed.

FIG. 4 is a side elevation view of the lip skin and forward bulkhead of the nacelle and the spray tube of the anti-icing system.

FIG. 5 is an isometric view of the forward bulkhead and the anti-icing system.

FIG. 6 is a front elevation view of the forward bulkhead and the anti-icing system.

FIG. 7 is a front isometric view of a portion of the forward bulkhead and the anti-icing system.

FIG. 8 is a front elevation view of a portion of the forward bulkhead and the anti-icing system.

FIG. 9 is a front isometric view of a portion of the forward bulkhead and the anti-icing system.

FIG. 10 is a front isometric view of the forward bulkhead and the anti-icing system.

FIG. 11 is a rear isometric view of the anti-icing system.

FIG. 12 is a rear isometric view of a portion of the anti-icing system.

FIG. 13 is a side elevation view of the lip skin and forward bulkhead of the nacelle and an expansion joint of the anti-icing system.

FIG. 14 is a cross-sectional view of the expansion corresponding to section 14-14 of FIG. 13.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Turning now to the drawing figures, and particularly FIG. 1, an aircraft engine assembly 10 in which embodiments of an anti-icing system of the present invention may be used is illustrated. The aircraft engine assembly 10 broadly includes an engine and fan assembly 12 and a nacelle 14 for supporting and partially enclosing the engine and fan assembly 12. By way of example, the engine assembly 10 may be configured to be attached to the aft portion of a fuselage, such as on a GULFSTREAM aircraft, or below a wing of an aircraft such as the BOEING 737 or 747.

The particular size and shape of the various components of the anti-icing system may vary substantially from one embodiment of the invention to another without departing from the spirit or scope of the invention. Therefore, while dimensions and proportions of various components are set forth herein, it will be understood that such information is provided by way of example and does not limit the scope of the invention as recited in the claims unless expressly indicated. Similarly, embodiments of the anti-icing system may be sized and configured for attachment to any aircraft.

The engine and fan assembly 12 is conventional and includes an engine and a fan coupled for rotation to the engine. The engine is preferably a gas turbine engine but may be any other conventional type of engine. The fan is also conventional and includes a number of circumferentially spaced fan blades. As viewed from the perspective of FIG. 1, air utilized by the engine and fan assembly 12 to produce thrust enters from the left, is compressed by the fan blades, and is forced out vents or ducts on the right.

The nacelle 14 supports and partially encloses the engine and fan assembly 12 and may be formed of any suitable material such as aluminum, steel, fiberglass or other conventional metal or composite material. The nacelle 14 includes an inlet section 16 for directing air toward the engine and fan assembly 12, and a main section 18 for supporting the engine and fan assembly 12. Because the inlet section 16 is forward of the engine and therefore not heated directly by the engine, it is prone to the accumulation of ice, especially on its leading edge.

As best illustrated in FIGS. 2, 3, and 4 and 13, the inlet section 16 includes a forward lip skin 20 which is riveted or otherwise attached to a forward bulkhead 22. Referring specifically to FIG. 2, the inlet section 16 also includes an outer barrel 24 which is riveted or otherwise attached between the forward bulkhead 22 and an aft bulkhead 26. The nacelle 14 may also include one or more acoustic panels 28 for absorbing noise generated by the engine and fan assembly 12. The acoustic panels 28 may be attached to or integrated within an inner wall of the inlet section 16 and may be constructed of any suitable acoustic material such as graphite epoxy plies or bonded aluminum layers.

As best shown in FIGS. 4 and 13, the lip skin 20 and forward bulkhead 22 define a forward plenum 30 or compartment that houses components of the anti-icing assembly. Referring again to FIG. 2, the aft bulkhead 26, forward bulkhead 22, outer barrel 24, and acoustic panel 28 define a rear plenum 32 or compartment for receiving other components of the anti-icing system.

The anti-icing assembly is configured to carry and direct heated gasses to the nacelle 14, and particularly to the forward plenum 30, to prevent accumulation of ice on the lip skin 20. An embodiment of the anti-icing assembly broadly comprises a hollow spray tube 34 comprising a plurality of tube sections 34a-d for carrying hot gasses and directing them toward the lip skin 10; a plurality of fixed support fasteners 36 each configured to secure one of the sections 34a-c to the forward bulkhead 22 or other support structure of the aircraft; a plurality of expansion joints 37 interconnecting the tube sections 34a-d; a supply duct 38 for delivering the hot gasses from the aircraft engine to the spray tube; and an exhaust duct 40 (see FIG. 3) for exhausting the gasses from the forward plenum 30.

In more detail, the spray tube 34 is positioned in the forward plenum 30 as shown in FIGS. 2, 4, and 13 and in one embodiment is formed from a plurality of arcuate tube sections 34a-d interconnected by a plurality of expansion joints. The illustrated embodiment of the spray tube 34 includes four sections each spanning an arc of approximately ninety degrees. Three fixed supports are each welded or otherwise attached to one of the tube sections 34a, 34c, 34d. A fourth tube section 34d is fixedly held in place by the supply duct 38. The tube section 34d and the supply duct 38 may be integrally formed as a single, monolithic piece or may be welded or otherwise connected. The tube sections 34a-d and expansion joints 37 together form a continuous circular hollow channel through which the hot gasses flow.

The tube sections 34a-d are hollow and may be formed of titanium or other material capable of withstanding high gas temperatures and pressures. Each of the tube sections may present in internal diameter of between about 1.0 inch and 3.0 inches, more preferably between about 1.5 inches and 2.5 inches. In one embodiment, the tube sections 34a-d have an internal diameter of approximately 1.936 inches and an external diameter of approximately 2.00 inches.

The spray tube 34 includes a plurality of apertures so that the tube 34, when supplied with pressurized hot gasses from the aircraft engine, distributes the hot gasses in the forward plenum 30 to prevent accumulation of ice or to remove ice from the outer surface of the lip skin 20. As depicted in FIG. 4, one embodiment of the spray tube 34 includes three rows of apertures, with a first row 42 positioned approximately 10° below the powerplant water line (PWL) and having 98 apertures, each approximately 0.113 inches in diameter and spaced approximately 1.6 inches apart; a second row 44 positioned approximately 40° below PWL and having 99 apertures each approximately 0.0935 inches in diameter and spaced approximately 1.6 inches apart; and a third row 46 positioned approximately 130° below PWL and having 98 apertures each approximately 0.052 inches in diameter. With this configuration, the spray tube 34 concentrates most or all of the hot gasses on the inner portions of the lip skin 20 to prevent ice from accumulating thereon and shedding into the engine assembly where it can damage the engine fan blades.

In accordance with one aspect of the invention, the ends of adjacent tube sections 34a-d within each expansion joint 37 define a thermal expansion gap 48 between the tube sections. The thermal expansion gap 48 accommodates thermal expansions and contractions of the sections 34a-d caused by the hot gasses carried in the tube. As the spray tube 34 heats up, the length of each section 34a-d increases and the gaps 48 shrink. Conversely, as the spray tube 34 cools, the length of each section 34a-d decreases and the gaps 48 widen. The width of the expansion gaps 48 may be selected based on the size and materials of the tube sections 34a-d, the temperature of the hot gasses carried by the spray tube, or other factors, and in some embodiments is between 0.1 inch and 0.5 inches. In a specific embodiment, the gaps 48 are approximately 0.15, 0.2, or 0.25 inches wide. Although specific gap widths are disclosed and illustrated herein, the thermal expansion gaps 48 may be of different sizes without departing from the scope of the invention.

With particular reference of FIGS. 7 and 9, each fixed support 36 comprises a support bracket 50 for attachment to the forward bulkhead 22 or other aircraft support structure and a spray tube mount 52 for holding the spray tube 34 and attaching it to the support bracket 50. The support bracket 50 may be formed from a strip of metal which is bent or otherwise formed to define a generally planar section 54 and a pair of depending and angled legs 56. The legs 56 are welded, riveted, or otherwise fastened to the forward bulkhead 22 or other support structure. The supply duct 38 or associated connection fixedly secures the tube section 34b in place such that there is no fixed support associated with that tube section.

With particular reference to FIGS. 13 and 14, each of the expansion joints 37 slidably receives end margins of adjacent tube sections, such as the end margins of sections 34a and 34d as illustrated in FIG. 14. The tube sections 34a-d slide into and out of the expansion joints 37 as the tube sections expand and contract in response to temperature changes, as explained above. A support bracket 50 and mount 52, explained in detail above with regard to the fixed supports 36, attach the expansion joint 37 to the bulkhead 22 or other structure. When used with the expansion joint 37, the mount 52 attaches to an expansion joint housing 60 rather than directly to the spray tube 34.

The expansion joint housing 60 has a hollow, cylindrical inner profile configured to snuggly receive the end margins of adjacent tube sections. A first end 62 is angled slightly relative to a second end 64 of the housing 60 so that the ends 62, 64 are in axial alignment with the tube sections mounted therein. The angle between the first end 62 and the second end 64 will depend, in part, on the radius of curvature of the tube sections 34. By way of example, the first end 62 and the second end 64 may be separated by an angle of between 160° and 179°.

Opposed axial margins of the housing 60 define annular recesses 66, 68 that receive and retain O-rings 70 or similar annular sealing elements that provide an air-tight or nearly air-tight seal between the housing 60 and the tube sections. The O-rings 70 may be seated in the recesses 66, 68 but not fixedly attached therein to allow the O-rings to roll or otherwise accommodate movement of the tube sections relative to the expansion joint housing.

The expansion joint housing 60 is preferably formed of titanium or other material which can withstand high gas pressures and are welded or otherwise attached between adjacent tube sections. It will appreciated that the thermal expansion gaps 48 substantially reduce mechanical stresses on the fixed supports 36 and the spray tube 34 and thus reduce the likelihood of mechanical failure in the supports 36 and the spray tube 34.

As best illustrated in FIGS. 10 and 11, the supply duct 38 is connected between spray tube section 34b and a source of hot gasses from the aircraft engine assembly so that it may deliver the hot gasses to the spray tube 34. In one embodiment, the supply duct 38 is made of titanium and has an internal diameter of approximately 1.936 inches and an external diameter of approximately 2.00 inches. Because the supply duct 38 is exposed to high temperature and pressure gasses from the aircraft engine assembly 12, it may be prone to rupturing. To prevent hot gasses from escaping from a rupture in the supply duct 38 and entering the rear plenum 32 and damaging the outer barrel 24 or acoustic panels 28, the supply duct 38 may be enclosed within a relatively larger diameter shroud 70 (FIG. 3). The shroud 70 is sealed around the supply duct 38 and is not separately vented so that, in the event of rupture of the supply duct 38, the shroud 70 permits the supply duct 38 to continue delivering hot gasses to the spray tube 34.

The exhaust duct 40 exhausts gasses from the forward plenum 30 to a location outside of the nacelle 14. The exhaust duct 40 is conventional and may be formed from a titanium pipe having an internal diameter of approximately 2.936 inches and an external diameter of approximately 3.00 inches.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An anti-icing system for a nacelle inlet of an aircraft engine, the system comprising:
a spray tube for directing hot gasses toward a portion of the nacelle inlet, the spray tube comprising a plurality of sections arranged such that the ends of adjacent sections are separated by a space thereby defining a thermal expansion gap between the sections; and
a plurality of expansion joints, each expansion joint connecting adjacent ends of the tube sections to thereby enclose the thermal expansion gap defined by the adjacent ends, each expansion joint allowing the adjacent ends of the tube sections to move within the joint.

2. The anti-icing system of claim 1, further comprising a plurality of fixed supports each rigidly connecting one of the spray tube sections to a support structure of the aircraft engine.

3. The anti-icing system of claim 2, one of the fixed supports being a supply duct.

4. The anti-icing system of claim 1, each of the spray tube sections presenting an arcuate shape such that the spray tube presents a circular shape.

5. The anti-icing system of claim 1, each of the expansion joints presenting a cylindrical shape with opposing ends, each end of each expansion joint being configured to receive an end of a spray tube section.

6. The anti-icing system of claim 5, each expansion joint including—
a first annular seal positioned on a first end of the joint for engaging an end of a first spray tube section inserted into the first end, and
a second annular seal positioned on a second end of the joint for engaging an end of a second spray tube section inserted into the second end.

7. The anti-icing system of claim 1, each of the thermal expansion gaps being between 0.1 and 0.5 inches wide when the spray tube is at an ambient temperature.

8. The anti-icing system of claim 1, each of the thermal expansion gaps being between 0.15 and 0.25 inches wide when the spray tube is at an ambient temperature.

9. The anti-icing system of claim 1, each of the spray tube sections presenting an internal diameter between 1.0 inch and 3.0 inches.

10. The anti-icing system of claim 1, each of the spray tube sections presenting an internal diameter between 1.5 inches and 2.5 inches.

11. The anti-icing system of claim 1, the spray tube being positioned between a forward engine bulkhead and a forward lip skin of the nacelle inlet.

12. The anti-icing system of claim 11, the spray tube including a plurality of apertures for directing the hot gasses toward the forward lip skin, the apertures being positioned on the spray tube to direct the hot gasses only toward inner portions of the lip skin.

13. The anti-icing system of claim 1, further comprising a supply duct for delivering hot gasses generated by the aircraft engine to the spray tube, and an exhaust duct for exhausting gasses from the nacelle inlet.

14. An anti-icing system for a nacelle inlet of an aircraft engine, the system comprising:
a circular spray tube for directing hot gasses toward a portion of the nacelle inlet, the spray tube comprising a plurality of arcuate sections arranged such that the ends of adjacent sections are separated by a space thereby defining a thermal expansion gap between the sections;
a plurality of expansion joints, each expansion joint rigidly connected to a support structure of the aircraft engine and connecting adjacent ends of the tube sections to thereby enclose the thermal expansion gap defined by the adjacent ends, each expansion joint allowing the adjacent ends of the tube sections to move within the joint; and
a plurality of fixed supports each rigidly connecting one of the spray tube sections to the support structure of the aircraft engine.

15. The anti-icing system of claim 14, the spray tube being positioned between a forward engine bulkhead and a forward lip skin of the nacelle inlet.

16. The anti-icing system of claim 15, the circular spray tube including a plurality of apertures for directing the hot gasses toward the lip skin of the nacelle inlet, the apertures being positioned on the spray tube to direct the hot gasses only toward the inner portions of the lip skin.

17. The anti-icing system of claim 14, each of the thermal expansion gaps being between 0.1 and 0.5 inches wide when the spray tube is at an ambient temperature.

18. The anti-icing system of claim 14, each of the thermal expansion gaps being between 0.15 and 0.25 inches wide when the spray tube is at an ambient temperature.

19. The anti-icing system of claim 14, further comprising a supply duct for delivering hot gasses generated by the aircraft engine to the spray tube, and an exhaust duct for exhausting gasses from the nacelle inlet.

20. The anti-icing system of claim 14, each of the spray tube sections presenting an internal diameter between 1.5 inches and 2.5 inches.
